(19) United States
(12) Patent Application Publication
(10) Pub. No.: US 2005/0224272 A1
(43) Pub. Date: Oct. 13, 2005

(54) Ergonomic vehicle control system

(76) Inventor: Francis Crawford JR., Honolulu, HI (US)

Correspondence Address: ASHKAN NAJAFI, P.A., 6817 SOUTHPOINT PARKWAY, SUITE 2301, JACKSONVILLE, FL, 32216, US

(21) Appl. No.: 10/821,700

(22) Filed: Apr. 9, 2004

(51) Int. Cl. B60K 7/00

(52) U.S. Cl. 180/308

(57) ABSTRACT

An ergonomic vehicle control system includes a control panel, a plurality of hydrostatic motors, a speed gear and a plurality of hydraulic lines for connecting the speed gear to the plurality of hydrostatic motors. The plurality of hydrostatic motors are operably connected to a plurality of vehicle wheels. The control system further includes a steering box and a hydrostatic pump operably connected thereto. A first controller is connected to the control panel, the steering box and the hydrostatic pump respectively. The control system further includes a second controller connected to the control panel and the speed gear respectively. The control panel further includes an elongated control lever electrically coupled to the first and second controllers so that an operator may effectively control movement of a vehicle. Such a control panel may be operably positioned on either side of a vehicle.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to vehicle control devices and, more particularly, to a vehicle control device for controlling multiple vehicular functions with one hand.

2. Prior Art

The operation of a motor vehicle requires the coordination of a variety of motor and sensory skills. A driver must steer and operate dashboard functions such as turn signals, headlights, and wipers with his hands. The accelerator pedal and brake pedal are typically operated by one foot of a driver. In vehicles with manual transmissions, the driver's other foot is used to engage the clutch.

Due to the coordination involved in operating numerous foot and hand pedals, it is easy for an operator to fail to timely or accurately engage such devices, resulting in accidents or close calls. This is especially true for elderly or handicapped people who may suffer from reduced physical capabilities, making it difficult for them to safely operate a vehicle.

These hand and foot controls are necessary because of the conventional transmission, drive train and braking methods found on most motor vehicles today. The use of these different systems requires a large internal combustion power source due to the loss of energy created by the transfer of energy from the power source to the transmission to the drive mechanism. This decreases fuel economy, resulting in greater operating costs.

A transmission-free motor vehicle operable by a single control mechanism would be safer, more convenient, and easier to use than conventional systems. It would enable handicapped and elderly people to better operate their vehicles and would be cheaper to maintain.

Accordingly, a need remains for a motor vehicle control system that is transmission-free and has just one control mechanism for throttle, braking and steering.

### BRIEF SUMMARY OF THE INVENTION

In view of the foregoing background, it is therefore an object of the present invention to provide an ergonomic vehicle control system for assisting drivers to operate a vehicle. These and other objects, features, and advantages of the invention are provided by a control system including a control panel electrically coupled to a vehicle dashboard and operable by a driver for generating a plurality of input signals so that a vehicle can be selectively operated. The control system further includes a plurality of hydrostatic motors, a Waterbury speed gear and a plurality of hydraulic lines for connecting the speed gear to the plurality of hydrostatic motors. The plurality of hydrostatic motors are operably connected to a plurality of vehicle wheels respectively for causing same to rotate at variable speeds.

The control panel further includes a global positioning system for providing driving directions to a vehicle operator and a locking mechanism connected to the control panel for allowing an operator to selectively adjust the control panel to a predetermined position. The control panel further includes an elongated control lever electrically coupled to the first and second controllers so that an operator may effectively control movement of a vehicle.

The control system further includes a steering box and a hydrostatic pump operably connected thereto. The hydrostatic pump contains a predetermined volume of fluid for selectively generating and transmitting fluid pressure to the steering box according to the plurality of input signals. The hydrostatic pump and the speed gear are operably connected to a vehicle engine for cooperating therewith to control vehicle speed.

A first controller is connected to the control panel, the steering box and the hydrostatic pump respectively for receiving select ones of the plurality of input signals and generating a plurality of corresponding output signals for controlling a vehicle direction of travel. The control system further includes a second controller connected to the control panel and the speed gear respectively for receiving alternate ones of the plurality of input signals and generating a plurality of corresponding output signals for controlling vehicle speed. Advantageously, the second controller includes a mechanism for stopping a vehicle without employment of conventional brakes. Of course, the first and second control panels may be operably positioned on either side of a vehicle.

The control system further includes a plurality of elongated roll bars having opposed end portions connected to selects portions of vehicle frame. Such plurality of roll bars preferably extend across a vehicle width for providing structural support thereto. Advantageously, the present invention further includes a mechanism for deploying a plurality of airbags mounted on the plurality of roll bars. Such a deploying mechanism causes the plurality of roll bar airbags to deploy down and forward to thereby improve occupant safety during operating conditions.

Advantageously, an adjustable mirror is mounted above the first and second controllers and is selectively pivotal along an x-axis and y-axis, respectively. Such a mirror includes a plurality of independently movable sections disposed adjacent each other along a substantially horizontal plane and extending across a select portion of a vehicle interior so that an operator may have a line of sight extending in a plurality of directions. Furthermore, the exterior side-view mirrors can be independently controlled by a pair of dash mounted levers that can be reached by either the driver or the passenger to further assist the vehicle occupants obtain a visible light of sight.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a top plan view showing a vehicle control system in a preferred environment, in accordance with the present invention;

FIG. 2 is an enlarged top plan view showing the speed gear, hydraulic pump and second controller shown in FIG. 1;

FIG. 3 is a front elevational view showing the control panel; and

FIG. 4 is a cross-sectional view of the control panel, taken along line 4-4.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

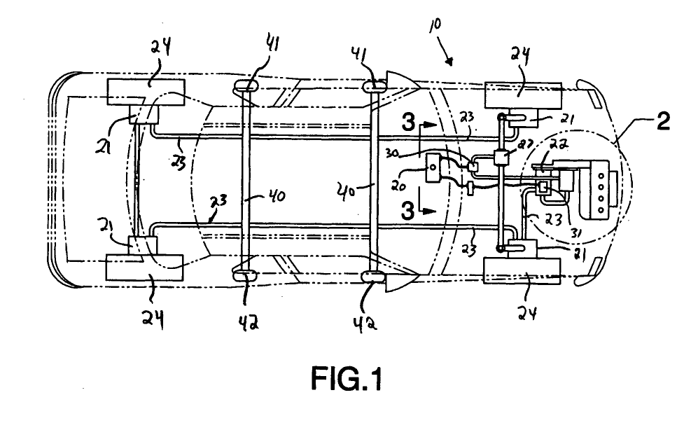

The apparatus of this invention is referred to generally in FIGS. 1-4 by the reference numeral 10 and is intended to provide an ergonomic vehicle control system for assisting drivers in operating a vehicle. It should be understood that the control system 10 may be used to operate many different types of vehicles and should not be limited to only automobiles.

Initially referring to FIG. 1, the control system 10 includes a control panel 20 electrically coupled to a vehicle dashboard and operable by a driver for generating a plurality of input signals so that a vehicle can be selectively operated. The system 10 further includes a plurality of hydrostatic motors 21, a Waterbury speed gear 22 and a plurality of hydraulic lines 23 for connecting the speed gear 22 to the plurality of hydrostatic motors 21. The plurality of hydrostatic motors 21 are operably connected to a plurality of vehicle wheels 24 respectively for causing same to rotate at variable speeds. The speed gear 22 and hydrostatic motors 21 eliminate the need for a transmission and drive train, thereby increasing fuel economy and reducing maintenance costs.

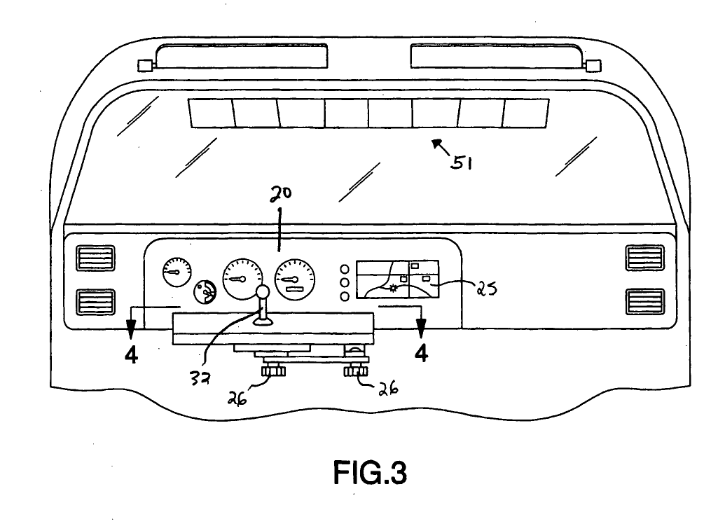

Now referring to FIG. 3, the control panel 20 further includes a global positioning system 25 for providing driving directions to a vehicle operator and a locking mechanism 26 connected to the control panel 20 for allowing an operator to selectively adjust the control panel 20 to a predetermined position. This enables a user to position the control panel where it is most comfortable to operate.

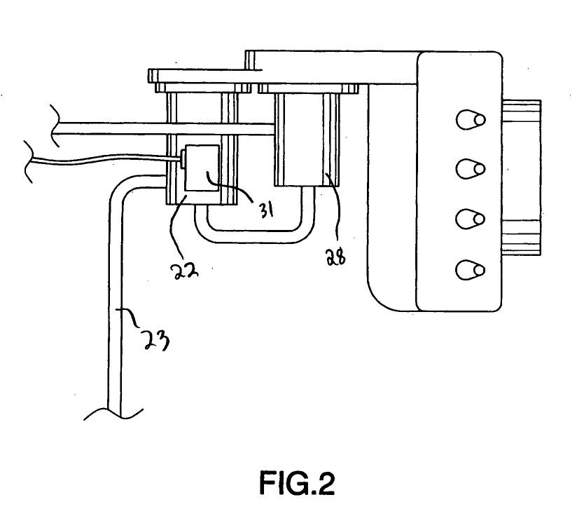

Now referring to FIG. 2, the control system 10 further includes a steering box 27 and a hydrostatic pump 28 operably connected thereto. The hydrostatic pump 28 contains a predetermined volume of fluid for selectively generating and transmitting fluid pressure to the steering box 27 according to the plurality of input signals. The hydrostatic pump 28 and the speed gear 22 are operably connected to a vehicle engine for cooperating therewith to control a vehicle speed.

Referring back to FIG. 1, a first controller 30 is connected to the control panel 20 and the steering box 27 and the hydrostatic pump 28 respectively for receiving select ones of the plurality of input signals and generating a plurality of corresponding output signals for controlling a vehicle direction of travel. The control system 10 further includes a second controller 31 connected to the control panel 20 and the speed gear 22 respectively for receiving alternate ones of the plurality of input signals and generating a plurality of corresponding output signals for controlling a vehicle speed. Advantageously, the second controller includes a mechanism for stopping a vehicle without employment of conventional brakes. Of course, the first and second control panels may be operably positioned on either side of a vehicle.

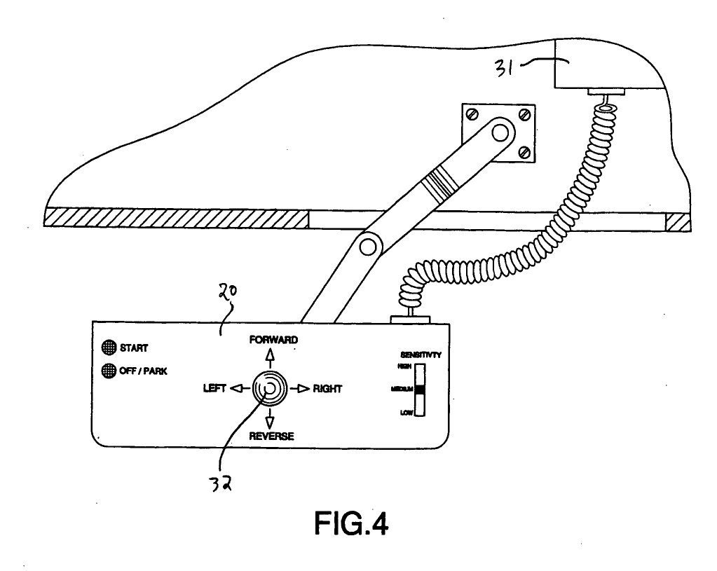

The control panel 20 further includes an elongated control lever 32 electrically coupled to the first 30 and second 31 controllers so that an operator may effectively control movement of a vehicle, as best shown in FIG. 4. This allows an operator to control speed and steering with just one hand, making it an ideal system for the elderly or handicapped. Advantageously, an adjustable mirror 51 is mounted above the first and second controllers and is selectively pivotal along an x-axis and y-axis, respectively. Such a mirror 51 includes a plurality of independently movable sections disposed adjacent each other along a substantially horizontal plane and extending across a select portion of a vehicle interior so that an operator may have a line of sight extending in a plurality of directions. Furthermore, the exterior side-view mirrors can be independently controlled by a pair of dash mounted levers that can be reached by either the driver or the passenger to further assist the vehicle occupants obtain a visible light of sight.

Still referring to FIG. 1, the control system 10 further includes a plurality of elongated roll bars 40 having opposed end portions 41, 42 connected to select portions of vehicle frame. Such plurality of roll bars 40 extend across a vehicle width for providing structural support thereto as well as protection in the event of a vehicle rollover. Advantageously, the present invention further includes a mechanism for deploying a plurality of airbags mounted on the plurality of roll bars. Such a deploying mechanism causes the plurality of roll bar airbags to deploy down and forward to thereby improve occupant safety during operating conditions.

The control system 10 provides a safer, more convenient method of vehicle operation. Its transmission-free design is more cost effective and efficient than current methods and its single control for speed, steering, and braking makes it easier to operate. This method improves overall control and handling of the vehicle and accommodates all types of drivers. The reduced weight of the vehicle would improve performance and fuel economy.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

1. A control system for assisting drivers to operate a vehicle, said system comprising:
a control panel electrically coupled to a vehicle dashboard and being operable by a driver for generating a plurality of input signals so that a vehicle can be selectively operated;
a plurality of hydrostatic motors and a speed gear and a plurality of hydraulic lines for connecting said speed gear to said plurality of hydrostatic motors, said plurality of hydrostatic motors being operably connected to a plurality of vehicle wheels respectively and for causing same to rotate at variable speeds;
a steering box and a hydrostatic pump operably connected thereto, said hydrostatic pump containing a predetermined volume of fluid for selectively generating and transmitting fluid pressure to said steering box according to said plurality of input signals;
a first controller connected to said control panel and said steering box and said hydrostatic pump respectively, said first controller for receiving select ones of said plurality of input signals and generating a plurality of corresponding output signals for controlling a vehicle direction of travel;
a second controller connected to said control panel and said speed gear respectively, said second controller for receiving alternate ones of said plurality of input signals and generating a plurality of corresponding output signals for controlling a vehicle speed; and
an adjustable mirror mounted above said first and second controllers and being selectively pivotal between along an x-axis and y-axis, said mirror comprising a plurality of independently movable sections disposed adjacent each other along a substantially horizontal plane and extending across a select portion of a vehicle interior so that an operator may have a line of sight extending in a plurality of directions.

2. The control system of claim 1, wherein said speed gear comprises:
a Waterbury speed gear.

3. The control system of claim 1, wherein said hydrostatic pump and said speed gear are operably connected to a vehicle engine and for cooperating therewith to control a vehicle speed.

4. The control system of claim 1, wherein said control panel further comprises: a global positioning system for providing driving directions to a vehicle operator.

5. The control system of claim 1, wherein said control panel further comprises: a locking mechanism connected to said control panel and for allowing an operator to selectively adjust said control panel to a predetermined position.

6. The control system of claim 1, wherein said control panel further comprises: an elongated control lever electrically coupled to said first and second controllers so that an operator may effectively control movement of a vehicle.

7. The control system of claim 1, further comprising:
a plurality of elongated roll bars having opposed end portions connected to select portions of a vehicle frame, said plurality of roll bars extending across a vehicle width and for providing structural support thereto.

8. A control system for assisting drivers to operate a vehicle, said system comprising:
a control panel electrically coupled to a vehicle dashboard and being operable by a driver for generating a plurality of input signals so that a vehicle can be selectively operated;
a plurality of hydrostatic motors and a speed gear and a plurality of hydraulic lines for connecting said speed gear to said plurality of hydrostatic motors, said plurality of hydrostatic motors being operably connected to a plurality of vehicle wheels respectively and for causing same to rotate at variable speeds;
a steering box and a hydrostatic pump operably connected thereto, said hydrostatic pump containing a predetermined volume of fluid for selectively generating and transmitting fluid pressure to said steering box according to said plurality of input signals;
a first controller connected to said control panel and said steering box and said hydrostatic pump respectively, said first controller for receiving select ones of said plurality of input signals and generating a plurality of corresponding output signals for controlling a vehicle direction of travel;
a second controller connected to said control panel and said speed gear respectively, said second controller for receiving alternate ones of said plurality of input signals and generating a plurality of corresponding output signals for controlling a vehicle speed;
a plurality of elongated roll bars having opposed end portions connected to select portions of a vehicle frame, said plurality of roll bars extending across a vehicle width and for providing structural support thereto; and
an adjustable mirror mounted above said first and second controllers and being selectively pivotal between along an x-axis and y-axis, said mirror comprising a plurality of independently movable sections disposed adjacent each other along a substantially horizontal plane and extending across a select portion of a vehicle interior so that an operator may have a line of sight extending in a plurality of directions.

9. The control system of claim 8, wherein said speed gear comprises:
a Waterbury speed gear.

10. The control system of claim 8, wherein said hydrostatic pump and said speed gear are operably connected to a vehicle engine and for cooperating therewith to control a vehicle speed.

11. The control system of claim 8, wherein said control panel further comprises: a global positioning system for providing driving directions to a vehicle operator.

12. The control system of claim 8, wherein said control panel further comprises: a locking mechanism connected to said control panel and for allowing an operator to selectively adjust said control panel to a predetermined position.

13. The control system of claim 8, wherein said control panel further comprises: an elongated control lever electrically coupled to said first and second controllers so that an operator may effectively control movement of a vehicle.

14. A control system for assisting drivers to operate a vehicle, said system comprising:
a control panel electrically coupled to a vehicle dashboard and being operable by a driver for generating a plurality of input signals so that a vehicle can be selectively operated;
a plurality of hydrostatic motors and a speed gear and a plurality of hydraulic lines for connecting said speed gear to said plurality of hydrostatic motors, said plurality of hydrostatic motors being operably connected to a plurality of vehicle wheels respectively and for causing same to rotate at variable speeds;
a steering box and a hydrostatic pump operably connected thereto, said hydrostatic pump containing a predetermined volume of fluid for selectively generating and transmitting fluid pressure to said steering box according to said plurality of input signals, said hydrostatic pump and said speed gear are operably connected to a vehicle engine and for cooperating therewith to control a vehicle speed;
a first controller connected to said control panel and said steering box and said hydrostatic pump respectively, said first controller for receiving select ones of said plurality of input signals and generating a plurality of corresponding output signals for controlling a vehicle direction of travel;
a second controller connected to said control panel and said speed gear respectively, said second controller for receiving alternate ones of said plurality of input signals and generating a plurality of corresponding output signals for controlling a vehicle speed;
a plurality of elongated roll bars having opposed end portions connected to select portions of a vehicle frame, said plurality of roll bars extending across a vehicle width and for providing structural support thereto; and
an adjustable mirror mounted above said first and second controllers and being selectively pivotal between along an x-axis and y-axis, said mirror comprising a plurality of independently movable sections disposed adjacent each other along a substantially horizontal plane and extending across a select portion of a vehicle interior so that an operator may have a line of sight extending in a plurality of directions.

15. The control system of claim 14, wherein said speed gear comprises:
a Waterbury speed gear.

16. The control system of claim 14, wherein said control panel further comprises:
a global positioning system for providing driving directions to a vehicle operator.

17. The control system of claim 14, wherein said control panel further comprises:
a locking mechanism connected to said control panel and for allowing an operator to selectively adjust said control panel to a predetermined position.

18. The control system of claim 14, wherein said control panel further comprises:
an elongated control lever electrically coupled to said first and second controllers so that an operator may effectively control movement of a vehicle.
